(19) United States
(12) Patent Application Publication
(10) Pub. No.: US 2026/0162381 A1
(43) Pub. Date: Jun. 11, 2026

(54) Method and System for Interactive Customized Artificial Intelligence Avatars

(71) Applicants: Vishnu Sivadas, Rancho Cordova, CA (US); Antony George, Jena (DE)

(72) Inventors: Vishnu Sivadas, Rancho Cordova, CA (US); Antony George, Jena (DE)

(21) Appl. No.: 19/183,322

(22) Filed: Apr. 18, 2025

Related U.S. Application Data
(60) Provisional application No. 63/640,739, filed on Apr. 30, 2024.

(51) Int. Cl. G06T 19/00

(52) U.S. Cl. CPC G06T 19/006; G06T 2219/024

(57) ABSTRACT

The method and system for interactive customized artificial intelligence avatar trains at least one artificial intelligence (AI) avatar on an associated dataset. An audience member may interact with the artificial intelligence avatar. After being asked a question or receiving a message from the audience member the AI avatar provides a response. The system tracks the interaction between the audience member and the AI avatar. The system then checks the responses from the AI avatar to ensure accuracy. Finally, the dataset and audience member data is stored within the storage database for later access and learning.

### FIELD OF THE INVENTION

The present invention relates generally to a system that allows for user interaction with AI avatars based on any desired individual. More specifically, the present invention is a system that recreates virtual avatars based off information of an individual, preferably a notable individual but applicable to any individual.

### BACKGROUND OF THE INVENTION

Traditionally, academics, scholars, industry leaders, and artists have relied on static media such as written texts, presentations, and videos to communicate their knowledge and expertise. While these mediums provide valuable information, they often fail to capture the essence of the individual's personality, insights, and ability to engage with their audience. Static media lacks two key elements that are crucial for effective communication and knowledge sharing: personalization and interactivity. Static media cannot tailor content or delivery to the specific needs or interests of individual audience members. This can lead to a sense of disconnect and disengagement, as the audience feels like they are not being heard or understood. Furthermore, static media also cannot respond to audience feedback or questions in real-time. This creates a one-way communication channel that limits the depth of engagement and the exchange of ideas.

An objective of the present invention is to provide users with a system that transforms the way notable individuals or any target individual interacts with their audiences via AI avatars. The present invention intends to provide users with a system that is trained on an extensive dataset of the target individual's knowledge, experiences, and insights. In order to accomplish that, a preferred embodiment of the present invention comprises a learning stage, an interactive stage, and an integrity checking stage. Further, these stages all utilize an AI avatar, computing device, processing unit, and storage database. Thus, the present invention is an AI avatar system that bridges the gap between notable figures and their audiences by providing a seamless and always available interface for followers to interact with their favorite personalities.

### BRIEF DESCRIPTION OF THE DRAWINGS

FIG. 1 is an illustration of the present invention.

FIG. 2 is a block diagram of the system of the present invention.

FIG. 3 is a block diagram of the system of the present invention.

FIG. 4 is a flowchart diagram of the method of the present invention.

FIG. 5 is a flowchart diagram of the method of the present invention.

FIG. 6 is a flowchart diagram of the method of the present invention.

FIG. 7 is a flowchart diagram of the method of the present invention.

FIG. 8 is a flowchart diagram of the method of the present invention.

FIG. 9 is a flowchart diagram of the method of the present invention.

FIG. 10 is a flowchart diagram of the method of the present invention.

FIG. 11 is a flowchart diagram of the method of the present invention.

### DETAILED DESCRIPTION OF THE INVENTION

All illustrations of the drawings are for the purpose of describing selected versions of the present invention and are not intended to limit the scope of the present invention.

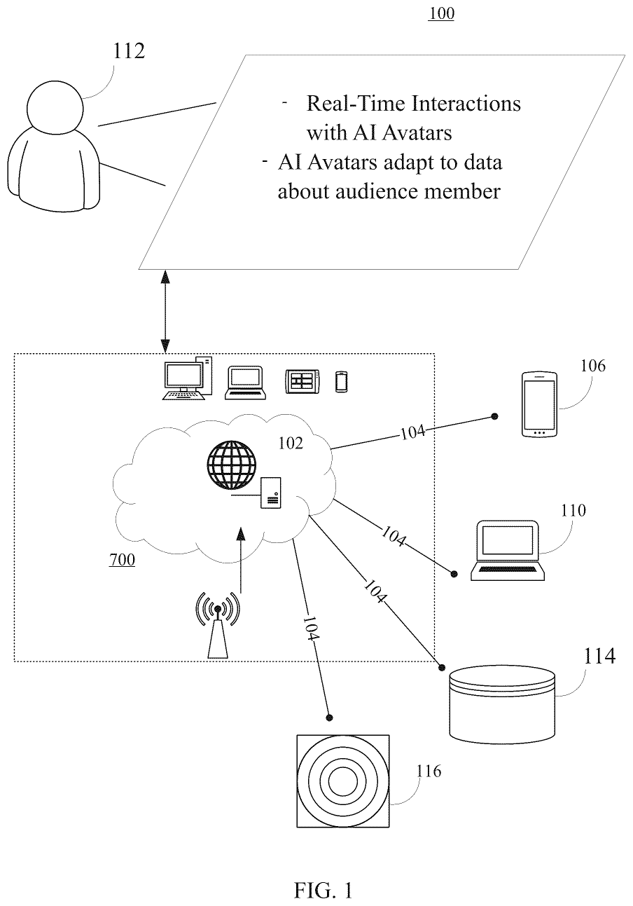

FIG. 1 is an illustration of an online platform 100 consistent with various embodiments of the present disclosure. By way of non-limiting example, the online platform 100 to enable interaction with an artificial intelligence (AI) avatar which may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1.

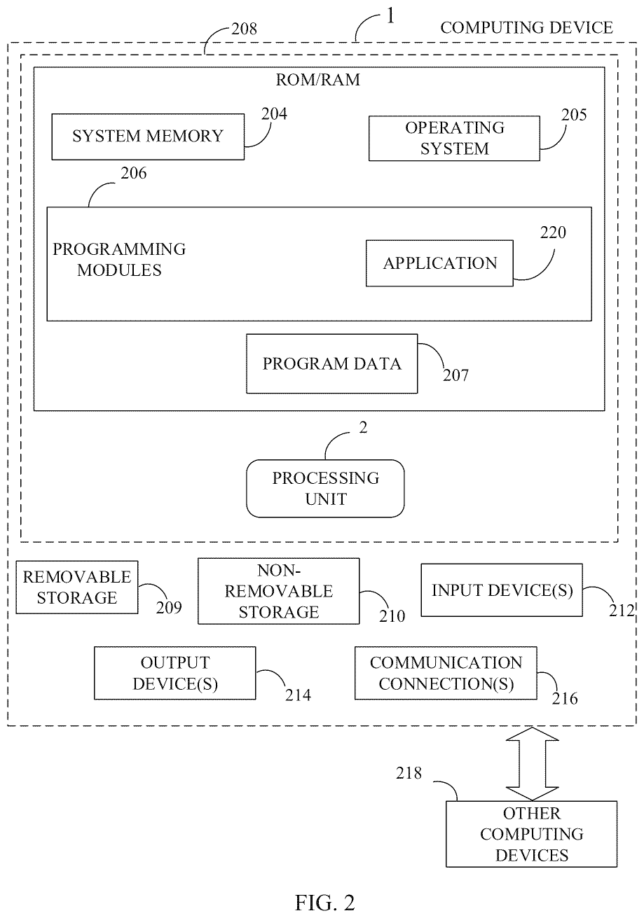

With reference to FIG. 2, a system consistent with an embodiment of the disclosure may include a computing device 1 or cloud service, such as computing device 1. In a basic configuration, computing device 1 may include at least one processing unit 2 and a system memory 204. Depending on the configuration and type of computing device 1, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 1's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 1 may have additional features or functionality. For example, computing device 1 may also include additional data storage databases 3 (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage databases 3, or any other medium which can be used to store information and which can be accessed by computing device 1. Any such computer storage media may be part of device 200. Computing device 1 may also have input device(s) 212 such as a keyboard 12, a mouse, a pen, a sound input device, a touch input device, a location sensor, a camera 14, a biometric sensor, etc. Output device(s) 214 such as a display, speaker 13, a printer, etc. may also be included. The aforementioned devices are examples and others may be used.

Computing device 1 may also contain a communication connection 216 that may allow device 1 to communicate with other computing devices 1, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 2, programming modules 206 (e.g., application 220 such as a media player) may perform processes including, for example, one or more stages of methods, algorithms, systems, applications, servers, databases as described above. The aforementioned process is an example, and processing unit 2 may perform other processes. Other programming modules that may be used in accordance with embodiments of the present disclosure may include machine learning applications

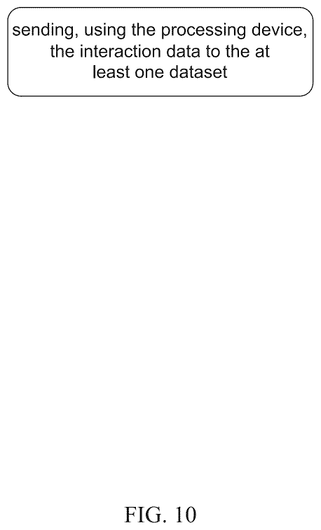

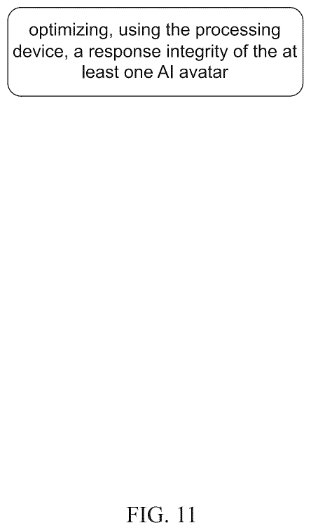

As can be seen in FIG. 1 through FIG. 11, the preferred embodiment of the present invention is a method and system that allows users to seek advice, gain insights, and engage in conversation with at least one AI avatar 41 based on any individual. The method of the present invention seeks to provide users with a system that utilizes at least one AI avatar 41 for personalized engagement with an audience member. The present invention is a method wherein where the system gathers and compiles all the data related to a target individual that the at least one AI avatar 41 is based on. The method allows for real time communication between the at least one AI avatar 41 and an audience member. The method of the present invention allows for each AI avatar 41 to be checked for accuracy via interactions with the target individual or another individual knowledgeable about the target individual. Thus, the present invention is an AI avatar 41 system that bridges the gap between notable figures and their audiences by providing a seamless and always available interface for followers to interact with their favorite personalities. For example, if an AI avatar 41 may be formed based on Neil deGrasse Tyson wherein the at least one AI avatar 41 utilizes all public and private information provided to the system to provide accurate responses, in a voice mimicking Neil deGrasse Tyson, to questions an audience member may have.

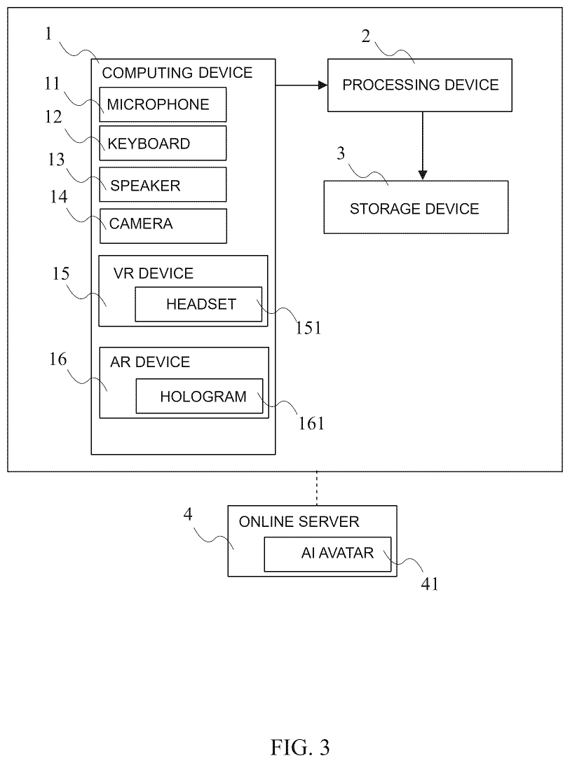

FIG. 3, illustrates a block diagram of a system for interactive customized AI avatars 41, in accordance with some embodiments. Accordingly, the system may include a computing device 1. Further the computing device 1 further comprises a microphone 11, keyboard 12, speaker 13, camera 14, virtual reality device 15, and augmented reality device 16. Further, the system may include a processing unit 2. Further the processing unit 2 may be configured for training at least one AI avatar 41 on at least one dataset. The processing unit 2 ensures that information gathered via public domain and via private domain are utilized with machine learning techniques to improve at least one AI avatar 41. Further, the system comprises a storage database 3. Further, the storage database 3 may be configured for storing at least one dataset wherein the at least one dataset comprises information relevant to how the at least one AI avatar 41 should respond and operate and information relevant to the audience member interacting with the at least one AI avatar 41. Further, the system comprises an online server 4. The online server 4 is in remote communication with the computing device 1, processing unit 2, and storage database 3. The online server 4 further comprises at least one AI avatar 41 and a graphical user interface.

Further, the virtual reality device 15 further comprises a headset 151. The virtual reality device 15 may be configured to show at least one artificial intelligence avatar through the headset 151. The augmented reality device 16 further comprises a hologram 161 and augmented reality glasses. The augmented reality device 16 may be configured to show at least one artificial intelligence avatar through the hologram 161. The augmented reality device 16 may be configured to show at least one artificial intelligence avatar through the augmented reality glasses.

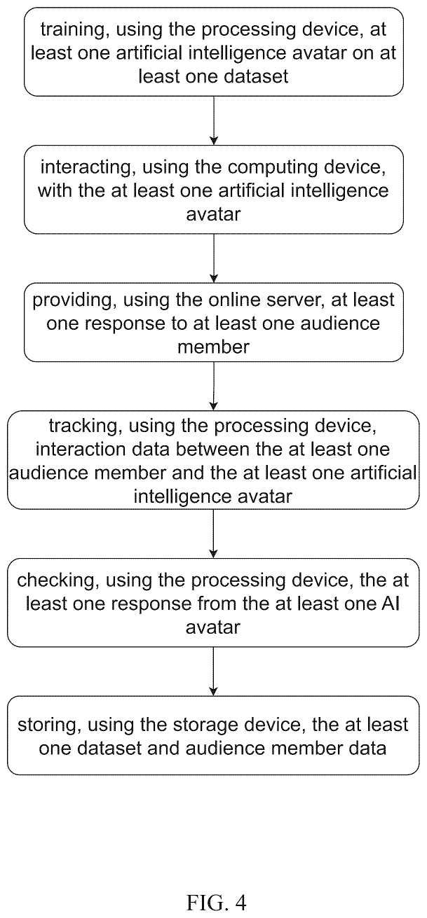

As can be seen in FIG. 4, the system used to execute the method of the present invention allows the present invention to function as at least one interactive AI avatar 41. To accomplish this, the method of the present invention trains at least one AI avatar 41 on at least one dataset. The artificial intelligence avatar is based on a target individual. Each dataset is associated with each AI avatar 41 and comprises information based on the targe individual's knowledge. The method of the present invention interacts with the at least one artificial intelligence avatar. After at least one AI avatar 41 is trained on experiences, opinions and speaking styles an audience member may interact with the AI avatar 41. In continuation of the previous example the AI avatar 41 may utilize videos, podcasts, audio clips, books, research papers, etc. to emulate Neil deGrasse Tyson's speaking patterns and thought patterns in order to properly interact with each audience member.

As can be seen in FIG. 4, the system used to execute the method of the present invention allows the present invention to communicate and record a conversation with at least one audience member. To accomplish this, the method of the present invention provides at least one response to at least one audience member. At least one AI avatar 41 may be accessed by at least one audience member wherein the audience member may conversate with the AI avatar 41. The system used to execute the method of the present invention tracks interaction data between the at least one audience member and the at least one artificial intelligence avatar. The interaction data tracks messages and questions sent and received by the at least one AI avatar 41 and the at least one audience member wherein the interaction data may further be utilized to train at least one AI avatar 41, associated with the interaction data, on appropriate responses to various questions and messages. For example, the system may record various responses made by the AI avatar 41 that represents Neil deGrasse Tyson to improve on similar responses in the future.

As can be seen in FIG. 4, the system used to execute the method of the present invention allows the present invention to check the responses made by the at least one AI avatar 41. To accomplish this, the method of the present invention checks the at least one response from the at least one AI avatar 41. An administrator is utilized to check the responses given by the AI avatar 41 for each target individual the AI avatar 41 is based on. In an alternative embodiment the AI and ML are utilized to check and optimize the integrity of the data. The method of the present invention stores the at least one dataset and audience member data. The at least one dataset and audience member data is stored within the storage database 3 wherein the at least one dataset and audience member data may be accessed at a later date. This design enables the AI avatar 41 to information from the storage database 3 in order to provide a cohesive conversation that seamlessly picks up from the last conversation the at least one audience member had with the at least one AI avatar 41.

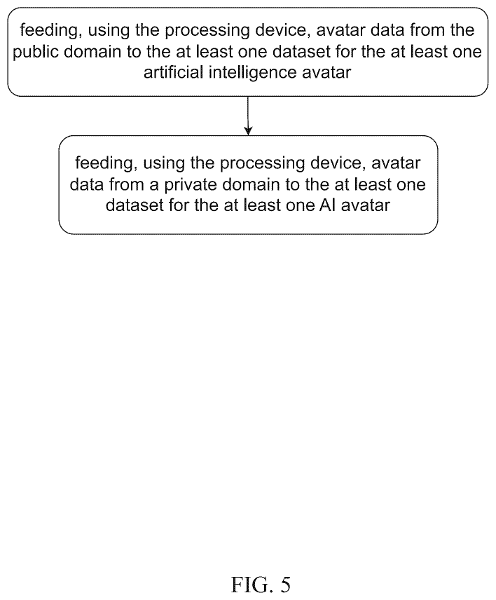

In reference to FIG. 5, a sub-process of the method of the present invention enables each AI avatar 41 to learn from public information and private information. To that end, the sub-process begins by feeding avatar data from the public domain to the at least one dataset for the at least one artificial intelligence avatar. The system utilizes machine learning to feed fata from the public domain to teach each AI avatar 41 based on a target individual. For example, the system monitors and pulls data from all social media accounts, online data, publications, patents, books, interviews (in print and visual media), books, podcasts, etc. that are associated with the target individual the AI avatar 41 is being created for. The sub-process continues by feeding avatar data from a private domain to the at least one dataset for the at least one AI avatar 41. The AI avatar 41 can further be based on a normal person with non-public information supplied to the system by a user. For example, this design allows for a normal person with cancer to upload information to the system to allow future generations to talk virtually with the target individual. The information that is fed to the system directly by the target individual or individual knowledgeable about the target individual is held at a higher fidelity than the information pulled from an online database by the system. It should be further noted that AI avatar 41 can learn and gather information in various ways while still staying within the scope of the present invention.

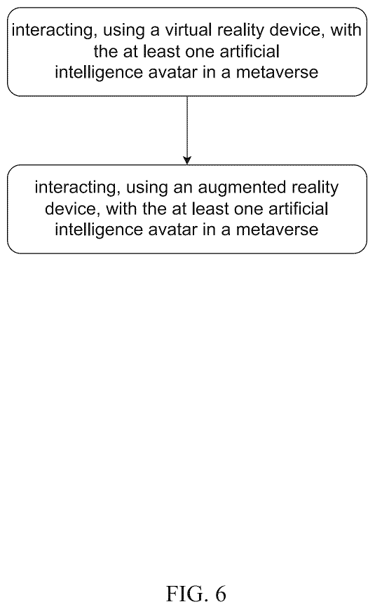

In reference to FIG. 6, a sub-process of the method of the present invention enables the AI avatar 41 to be interacted with through a variety of means. To that end, the sub-process begins by interacting with the at least one artificial intelligence avatar in a metaverse. An audience member to interact in real time with the AI avatar 41 and for the AI avatar 41 to provide personalized response based on data collected from the audience member. The sub-process continues by interacting with the at least one artificial intelligence avatar in a metaverse. Further, a UI/UX enables the user to utilize virtual reality gear to interact with the avatar and the avatar metaverse. For example, the home, workspace, or factory of the avatar can be recreated in the platform and the user can indulge in this, using virtual reality. The interactions between the AI avatar 41 and the audience member are personalized based on the background of the audience member. The system receives information about the audience member from online databases and from information directly delivered to the system about the audience member. The AI avatar 41 utilizes this information and dynamically adjusts responses to reflect the interests, background, and learning style of the audience member. This design fosters a sense of connection and engagement, thus making any experience more effective and enjoyable. Furthermore, the platform can collect data by monitoring user experiences via smart glass technology (e.g. Google glass or Samsung glass) or augmented reality/virtual reality gear. This will allow the platform to record the users real time experience.

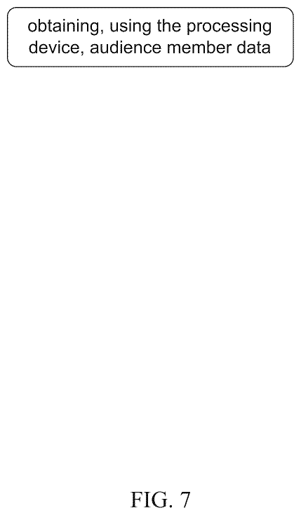

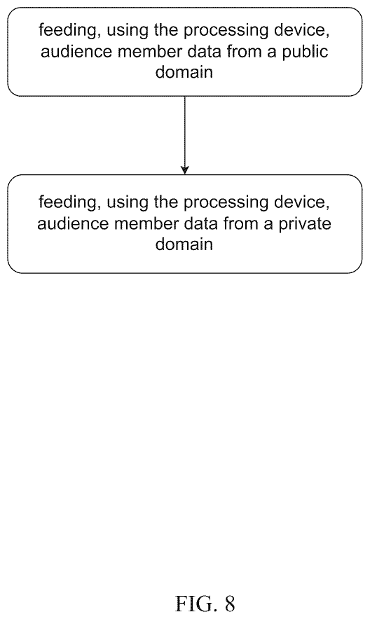

In reference to FIG. 7-8, a sub-process of the method of the present invention enables the AI to respond to an audience member by implementing audience member data associated with the audience member. To that end, the sub-process begins by obtaining audience member data. The audience member utilizes a computing device 1 (such as laptops, desktop computer, smartphone, etc.) to interact with the AI avatar 41. Furthermore, the sub-process continues by feeding audience member data from a public domain. Furthermore, the sub-process continues by feeding audience member data from a private domain. The computing device 1 allows the audience member to either type out a question or message or allows the audience member to an audio device to vocalize a question or message. The system tracks all questions and conversations had between the AI avatar 41 and the audience member and feeds this data to a database to further train each AI avatar 41 on appropriate responses to various questions and messages. Each AI avatar 41 can respond to questions, engage in discussions, and even hold virtual Q&A sessions. This real-time interaction allows for a dynamic exchange of ideas, allowing the AI avatar 41 to clarify concepts, address misconceptions, and delve deeper into topics that are of particular interest to the audience member.

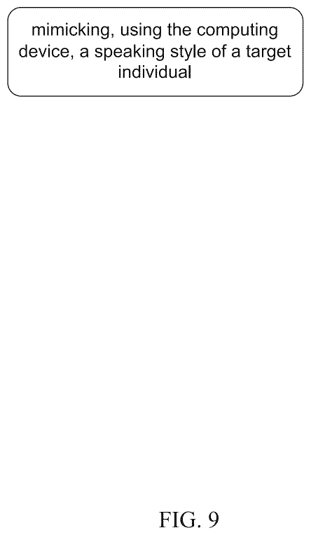

In reference to FIG. 9-11, a sub-process of the method of the present invention enables each AI avatar 41 to properly represent an associated target individual. To that end, the sub-process begins by mimicking a speaking style of a target individual. The AI avatar 41 is designed to resemble the target individual, can be trained to replicate the mannerisms of the person and synthesizes the sound of the real person to allow the AI avatar 41 to speak in the target individual's voice. This design allows the AI avatar 41 to be considered a digital twin and is a way of immortalizing the target individual. Furthermore, the data can be fed to the AI avatar 41 by connecting the documents the user writes, if the user is willing, with the platform, allowing the AI to learn and understand a specific thought process. Further, the user can feed data in real time while delivering a speech, providing an interview, or doing a podcast. These inputs can be collected in real time and can be used for training. The inputs can be collected via a camera 14 and/or a microphone 11. For example, the lectures or academic research presentations of a professor or scientist can be fed to the database in real time. Another sub-process begins by sending the interaction data to the at least one dataset. This enables the each AI avatar 41 to access the at least one dataset associated with the AI avatar 41 and pull from and learn from the information within the at least one dataset. Another sub-process continues by optimizing a response integrity of the at least one AI avatar 41. In an alternative embodiment AI and machine learning are utilized to check and optimize the integrity of the data. This allows the platform to accurately present the proper information and reject misinformation as the AI and machine learning platform evolves, eventually requiring minimal human involvement over time. The AI avatar 41 processes the stored information from a wide range of sources in order to provide comprehensive and insightful answers. Furthermore, the AI avatar 41 is designed to pull from the target individual's unique experiences and knowledge. Further, the AI avatars 41 are trained to capture the target individual's authentic voice, speaking style, and mannerisms. This design creates a sense of connection and trust between the audience member and the AI avatar 41 representing a target individual. The target individual can start a session with the AI avatar 41 based off of them and ask various questions. Based on the responses the target individual can either confirm or reject answers, to further teach the AI avatar 41 and improve accuracy. Each session with the AI avatar 41 is accessible by an audience member or user through an online platform which is accessible via a website or computer application. This allows the online platform to communicate with devices connected to the computing device 1 by accessing the online platform such as a keyboard 12, microphone 11, speaker 13, and camera 14. With all the components working in tandem with each other it can be seen that the present invention is an AI avatar 41 system that bridges the gap between notable figures and their audiences by providing a seamless and always available interface for followers to interact with their favorite personalities.

Although the invention has been explained in relation to its preferred embodiment, it is to be understood that many other possible modifications and variations can be made without departing from the spirit and scope of the invention as hereinafter claimed.

What is claimed is:

1. A method for interactive customized artificial intelligence avatars comprising:
training, using the processing unit, at least one artificial intelligence avatar on at least one dataset;
interacting, using the computing device, with the at least one artificial intelligence avatar;
providing, using the online server, at least one response to at least one audience member;
tracking, using the processing unit, interaction data between the at least one audience member and the at least one artificial intelligence avatar;
checking, using the processing unit, the at least one response from the at least one AI avatar; and
storing, using the storage device, the at least one dataset and audience member data.

2. The method for interactive customized artificial intelligence avatars as claimed in claim 1 comprising:
feeding, using the processing unit, avatar data from the public domain to the at least one dataset for the at least one artificial intelligence avatar; and
feeding, using the processing unit, avatar data from a private domain to the at least one dataset for the at least one AI avatar.

3. The method for interactive customized artificial intelligence avatars as claimed in claim 1 comprising:
interacting, using a virtual reality device, with the at least one artificial intelligence avatar in a metaverse; and
interacting, using an augmented reality device, with the at least one artificial intelligence avatar in a metaverse.

4. The method for interactive customized artificial intelligence avatars as claimed in claim 1 comprising obtaining, using the processing unit, audience member data.

5. The method for interactive customized artificial intelligence avatars as claimed in claim 4 comprising:
feeding, using the processing unit, audience member data from a public domain; and
feeding, using the processing unit, audience member data from a private domain.

6. The method for interactive customized artificial intelligence avatars as claimed in claim 1 comprising mimicking, using the computing device, a speaking style of a target individual.

7. The method for interactive customized artificial intelligence avatars as claimed in claim 1 comprising sending, using the processing unit, the interaction data to the at least one dataset.

8. The method for interactive customized artificial intelligence avatars as claimed in claim 1 comprising optimizing, using the processing unit, a response integrity of the at least one AI avatar.

9. A system for interactive customized artificial intelligence avatars comprising:
a computing device;
a processing unit;
a storage device;
an online server;
the online server being in remote communication with the computing device, processing unit, and storage device; and
the online server further comprising at least one artificial intelligence avatar and a graphical user interface.

10. The system for interactive customized artificial intelligence avatars as claimed in claim 9 wherein the computing device further comprising a microphone, keyboard, speaker, camera, virtual reality device, and augmented reality device.

11. The system for interactive customized artificial intelligence avatars as claimed in claim 10 comprising:
the virtual reality device further comprising a headset; and
the virtual reality device being configured to show at least one artificial intelligence avatar through the headset.

12. The system for interactive customized artificial intelligence avatars as claimed in claim 10 comprising:
the augmented reality device further comprising a hologram and augmented reality glasses;
the augmented reality device being configured to show at least one artificial intelligence avatar through the hologram; and
the augmented reality device being configured to show at least one artificial intelligence avatar through the augmented reality glasses.
